(19) United States
(12) Patent Application Publication
(10) Pub. No.: US 2024/0256999 A1
(43) Pub. Date: Aug. 1, 2024

(54) SYSTEM AND METHOD FOR BEHAVIORAL CLASSIFICATION

(71) Applicant: KNOCKRI, Toronto (CA)

(72) Inventors: David Adam MAYERS, North York (CA); Michael SKUPIEN, Toronto (CA); Raed SHABBIR, Brampton (CA); Faisal AHMED, Mississauga (CA)

(21) Appl. No.: 18/565,231

(22) PCT Filed: Jun. 3, 2022
(86) PCT No.: PCT/CA2022/050891

§ 371 Date: Nov. 29, 2023

Related U.S. Application Data
(60) Provisional application No. 63/196,876, filed on Jun. 4, 2021.

(51) Int. Cl. G06Q 10/0631; G06F 18/2415; G06F 40/169; G06F 40/205; G06F 40/289

(52) U.S. Cl. CPC G06Q 10/063112; G06F 18/2415; G06F 40/169; G06F 40/289; G06F 40/205

(57) ABSTRACT

Systems and methods for automating a behavioral interview are provided. One or more machine learning models may be trained to identify behavioral attributes based on text passages with different granularities. Candidates may respond to assessments, and responses may be converted to text. Text responses may be analyzed by the machine learning models and scores for behavioral attributes may be calculated.

### CROSS-REFERENCE TO RELATED APPLICATIONS

This claims the benefit of U.S. Provisional Patent Application No. 63/196,876, filed on Jun. 4, 2021, the entire contents of which are incorporated by reference in their entirety.

### FIELD

This relates generally to machine learning systems for classifying behavioral content, and in particular to systems and methods for identifying and/or evaluating behavioral content to determine behavioral attributes and skills associated therewith.

### BACKGROUND

Automation is becoming increasingly common in many fields. The automatic classification of data remains a challenging problem in many domains, as attempts at machine learning and artificial intelligence often bring with them the various biases (both conscious and unconscious) of the data on which they are based. Particularly in areas which relate to the assessment of people and/or the understanding of the behavior of a person, automation often serves to perpetuate biases against historically disadvantaged groups. This frequently relates to the use of training data (which itself is biased) to build models. This may also apply to both features (predictors) and targets (outcomes) used to build machine learning algorithms.

One area in which bias remains an inherent part of classification is the process of seeking and evaluating candidates for employment. Conscious and unconscious biases may affect every stage of the process, from the formulation of the language to be used in a job posting, the evaluation of the skills of a candidate based on their resume or a cognitive test, and the eventual selection of a successful candidate to hire. Such biases may result in suboptimal candidates being selected and wasted time in interviewing suboptimal candidates.

Accordingly, it would be beneficial to automate processes rife with inherent bias to provide more objective evaluations and criteria.

### SUMMARY

According to an aspect, there is provided a method of automating a behavioral interview to identify behavioral attributes in a text passage, the method comprising: developing a taxonomy of behaviors; annotating a training data set of text passages to identify a classification and/or location of behaviors associated with the text passages; training a machine learning model to predict one or more behaviors based on an input text passage; identifying one or more behavioral attributes required for a job; generating an assessment for prospective candidates, said assessment including one or more questions targeting evaluation of said one or more behavioral attributes; receiving a response to said assessment from one or more prospective candidates, wherein said response includes at least one of audio and text data; converting said response to a text passage; applying said machine learning model to said text passage to identify one or more predicted behaviors; weighting an importance for each of said one or more predicted behaviors; and calculating scores for the behavioral attributes using at least one of said importance and said identified predicted behaviors.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example server or client computing device;

FIG. 3 depicts a simplified arrangement of software at a server or client computing device;

FIG. 4 depicts an example framework or process of training machine learning models;

FIG. 5 depicts an example framework or process for an assessment module;

FIG. 6 depicts an example transcript after being analyzed to identify various behaviors;

FIG. 7 depicts an example framework or process for creating an assessment;

FIG. 8 depicts an example framework or process for determining a score based on responses provided by a candidate to an assessment;

FIG. 9 depicts an example graphical user interface containing example components of an assessment;

FIG. 10 depicts a streamlined process for interviewing a candidate;

FIG. 11 depicts an interview transcript which has been assessed for a number of behaviors;

FIG. 12 depicts an example graphical user interface displaying a scoring dashboard;

FIG. 13 depicts an example graphical user interface displaying a recruiter dashboard; and

FIG. 14 is a flow chart depicting an example process.

### DETAILED DESCRIPTION

Various embodiments described herein make use of computing systems configured to perform artificial intelligence and machine learning processes, particularly in the context of evaluating candidates for a job posting. However, it will be appreciated that systems and methods described herein may be applied more broadly than the job context, and may be applicable to many other situations in which human behavioral analysis is at issue. One of the biggest criticisms about Artificial Intelligence (AI) is related to bias and whether the AI is making the “right” decision based on the “right” features or set of features (predictors). This criticism is valid in many cases. However, a well-designed AI solution can be made to prove that decisions are being made based on appropriate features or combination of features (predictors) with the impact of bias reduced. In some cases, this can even be established using transparent models which make reasons for underlying decisions and scores more clear and objective.

In machine learning (ML), a subset of AI, an ML model learns from data fed into it (training data). Training data is typically data with a known quality or label which has been labeled or annotated and is known to be true. Any biases in the training data are generally compounded and made worse with ML and, at best, perpetuated. This situation occurred, for example, with Amazon in 2018 when they (likely unintentionally) created a biased algorithm against women by scraping historical resume data. In data science, there is a general understanding of what happens when the data used to train models is biased (the so-called “Garbage in, Garbage out” theory). Models taught with biased data tend to learn and act upon those biases when used in production.

There are two general types of supervised training processes: regression and classification. In regression models, the target that the model attempts to replicate is some scalar number or quantity. In the context of, for example, a video interview, this regression target could be the rating that a human reviewer gives a candidate based on the candidate's perceived level of skill.

In classification models, the target that the model attempts to replicate is whether or not a given sample or test case falls within a particular class (multi-class classification) or set of classes (multi-label classification). In the context of, for example, a video interview, this classification target could be which of a set of key attributes, qualities or scenarios each sentence of the interview transcript represents.

Previous attempts in the domain of video interviews have offered automatic scoring of a candidate through a regression or classification approach. For example, some models are trained end-to-end using human evaluators (i.e. subjective interviewer ratings) as the target. This method of training ML algorithms attempts to replicate the behavior of interviewers. A significant disadvantage of using human evaluators as a target in ML is that the resulting ML model will likely compound or at least reflect many of the biases of the subjective interviewers. It would be beneficial to avoid the propagation of such biases in a resulting ML model. Other models have used employee outcomes like performance or turnover as a target. Like human interview evaluations, these targets can also be biased.

Some embodiments described herein apply a classification approach to ML model training and candidate scoring. Instead of using the opinion of an interview response made by human evaluators as a target, or some other employee outcome (I.e. job performance, employee turnover) some embodiments include a natural language processing model trained to classify and/or localize behaviors spoken by an applicant during an interview. In some embodiments, a natural language processing model may be trained to classify and/or localize behaviors written by an applicant during or as part of an interview. These behaviors may relate to the skills required for performance on-the-job. In some embodiments, these behaviors may relate to personality traits, and/or any individual or group-level attributes that are of interest and can be measured through behavior. This training method may provide a more accurate depiction of the behavioral content within an applicant's interview than traditional methods of evaluation. This training method may also provide a higher degree of transparency to recruiters and applicants by clarifying the relationship between data extracted from an interview response and the applicant's scores. Therefore, embodiments described herein can allow for more accountability for the decisions made regarding the quality of an applicant's interview response.

Various embodiments of the invention are described herein with reference to the drawings.

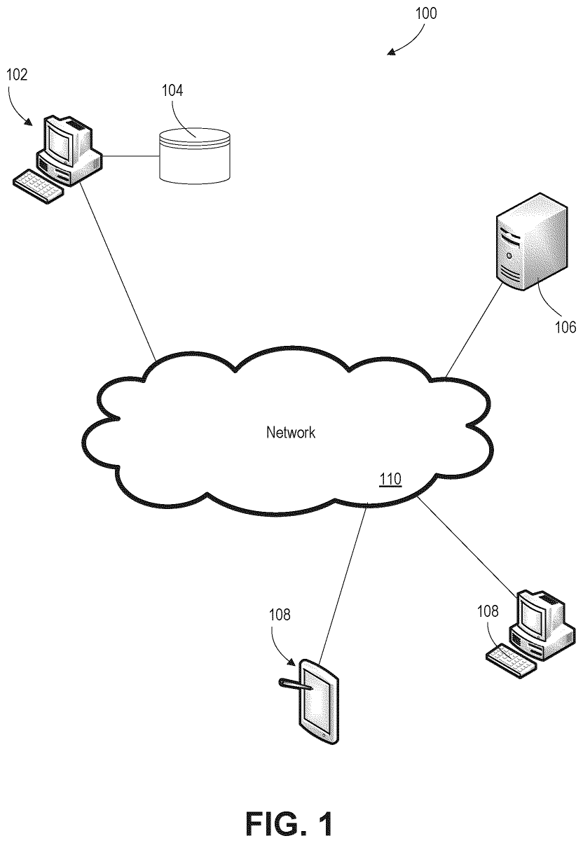

Various embodiments may be implemented using interconnected computer networks and components. FIG. 1 is a block diagram depicting components of an example computing system. Components of the computing system are interconnected to define a behavioral classification system 100. As used herein, the term “behavioral attribute measurement system” refers to a combination of hardware devices configured under control of software and interconnections between such devices and software. Such systems may be operated by one or more users or operated autonomously or semi-autonomously once initialized.

As depicted, system 100 includes at least one server 102 with a data storage 104 such as a hard drive, array of hard drives, network-accessible storage, or the like; at least one web server 106, a plurality of client computing devices 108. Server 102, web server 106, client computing devices 108 are in communication by way of a network 110. More or fewer, or none, of one or more of each device are possible relative to the example configuration depicted in FIG. 1. Data storage 104 may contain, for example, one or more data sets which may be used for the generation of data models in accordance with methods described herein. In some embodiments, data sets may include a data set such as the Occupational Network (O*NET).

The O*NET is a database that houses job-relevant information for over 1000 formal occupational titles. O*NET may be used as a trusted source for job-related information. O*NET provides information about the importance of Knowledge, Skills, Abilities, Interests, Work context, Work Activities, Detailed Work Activities, and related tasks for each occupation included in the O*NET. In addition, the O*NET includes a set of lay titles for each occupation that can be used to identify appropriate links between different lay titles and occupational titles. The O*NET provides a framework which identifies the most important types of information about work and integrates those types of information into a system (e.g. worker characteristics, worker requirements, experience requirements, occupational requirements, workforce characteristics, occupation-specific information, and the like, as described, for example at onetcenter.org/content.html).

The O*NET may be used to provide a validated link between behaviors and attributes. Specifically, the O*NET may provide datasheets that carry information regarding the importance and level of a set of 41 General Work Activities (GWAs), and 15 non-technical skills, referred to herein as Performance Indicators (PIs), across the range of some or all occupations. The GWAs represent generalized categories of work related behaviors that cover the universe of all behaviors across all occupations. To infer the relevance of each behavior in indicating a particular skill, a linear relationship between GWAs and PIs may be derived where each GWA is weighted based on the zero-order correlation to each PI.

With O*NET, it may be possible to derive a correlation between the importance of various work behaviors and skills. Some embodiments described herein may use this information to understand the relationship between the universe of work behavior and the skills that are being measured. Therefore, by understanding the behavior of a candidate, for example, in response to an interview question, it may be possible to estimate or otherwise infer the skill level based on the (sometimes linear) relationship between them.

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE networks.

As shown, server 102 and web server 106 are separate machines, which may be at different physical or geographical locations. However, server 102 and web server 106 may alternatively be implemented in a single physical device.

As will be described in further detail, server 102 may be connected to a data storage 104. In some embodiments, web server 106 hosts a website 400 accessible by client computing devices 108. Web server 106 is further operable to exchange data with server 102 such that data associated with client computing devices 108 can be retrieved from server 102 and utilized in connection with classification systems.

Server 102 and web server 106 may be based on Microsoft Windows, Linux, or other suitable operating systems. Client computing devices 108 may be, for example, personal computers, smartphones, tablet computers, or the like, and may be based on any suitable operating system, such as Microsoft Windows, Apple OS X or iOS, Linux, Android, or the like.

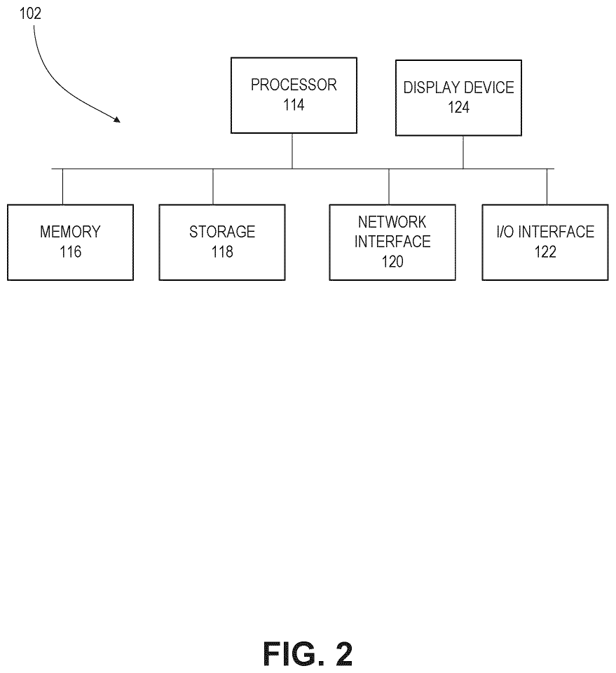

FIG. 2 is a block diagram depicting components of an example server 102, 106, or client computing device 108. As depicted, each server 102, 106, client device 108 includes a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects server 102, 106, or client computing device 108 to network 110. Network interface 120 may support domain-specific networking protocols. I/O interface 122 connects server 102, 106, or client computing device 108 to one or more storage devices (e.g. storage 104) and peripherals such as keyboards, mice, pointing devices, USB devices, disc drives, display devices 124, and the like.

Software may be loaded onto server 102, 106 or client computing device 108 from peripheral devices or from network 106. Such software may be executed using processor 114.

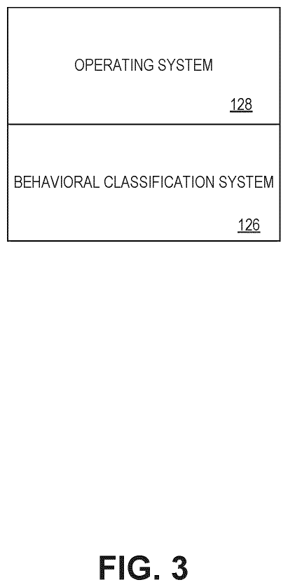

FIG. 3 depicts a simplified arrangement of software at a server 102 or client computing device 108. The software may include an operating system 128 and application software, such as behavioral classification system 126. Classification system 126 is configured to interface with, for example, one or more databases and/or computing devices and accept data and signals to generate models for classifying behavior based on content data such as that found in the O*NET database, and determining scores and/or rankings for various candidates based on applying a particular candidate's data (e.g. a candidate's interview transcript) to the developed models.

Some embodiments described herein may determine predicted behaviors relevant for behavioral attributes by using known (e.g. from research or via expert knowledge) relationships behaviors and behavioral attributes. Some embodiments may correlate the importance of behaviors to the importance of performance indicators (PIs) across a sample of jobs or occupations. Table 1 below outlines a plurality of non-technical skills, hereinafter referred to as PIs, along with corresponding definitions. However, organizational skill frameworks may tend to use more general skill categories to describe the relevant behavioral attributes (sometimes colloquially referred to as skills), for a job.

For example, “Growth-Mindset” is a skill found in many organizational skill frameworks. Growth-Mindset may be defined as “Knowledge of methods and ability to grasp new concepts, acquire new ways of seeing things, and revise ways of thinking and behaving, with the understanding that this is an ongoing business necessity.” In the case of Growth Mindset, several non-technical skills (PIs) are included as sub-facets of these overarching skills. For the Growth-Mindset skill, different parties may use a combination of active learning, learning strategies, and active listening as sub-facets of indicators of Growth Mindset. Therefore, automation and classification may require a link between at least one of the non-technical skills in Table 1 and the organizational skill being adapted. The link is generally established using subject matter expert (SME) content linkage analysis. SME content linkage analysis may be required in order to establish how important each behavior is to a particular skill to weight the behavior appropriately. In some embodiments, it may be possible to establish the importance of behaviors without relying on a relationship between behaviors and Pis. Rather than using nontechnical skills or Pis as an intermediary, work/training behavior importance for an organization's existing skills may be established by, for example, creating a cluster or set of the universe of work behaviors, which may be informed through expert judgment or some other approach. It is contemplated that the list of non-technical skills is not exhaustive and may be expanded and/or alternatives may be provided for organizational framework adaptation (e.g. focusing solely on behavior rather than a defined set of non-technical skills) or measure personality, ability, or workstyle.

TABLE 1

| Skill | Definition |
|---|---|
| Active Learning | The degree to which someone understands the implications of new |
| | information for both current and future problem-solving and decision- |
| | making. |
| Learning Strategies | The degree to which someone uses training/instructional methods and |
| | procedures appropriate for the situation when learning or teaching new |
| | things. |
| Active Listening | The degree to which someone pays attention to what other people are |
| | saying, takes time to understand their points, asks questions as |
| | appropriate, and does not interrupt at inappropriate times. |
| Coordination | The degree to which someone can adjust their actions in relation to |
| | others' actions |
| Persuasion | The degree to which Persuading others to change their minds or |
| | behavior. |
| Social Perceptiveness | The degree to which someone is aware of others' reactions and |
| | understanding why they react as they do. |
| Negotiation | The degree to which someone can bring others together and try to |
| | reconcile differences. |
| Critical Thinking | The degree to which someone uses logic and reasoning to identify the |
| | strengths and weaknesses of alternative solutions, conclusions or |
| | approaches to problems. |
| Complex problem solving | The degree to which someone can identify complex problems and |
| | review related information to develop and evaluate options and |
| | implement solutions. |
| Judgment and Decision | The degree to which someone can consider the relative costs and |
| Making | benefits of potential actions to choose the most appropriate one. |
| Systems Analysis | The degree to which someone can determine how a system should |
| | work and how changes in conditions, operations, and the environment |
| | will affect outcomes. |
| Systems Evaluation | The degree to which someone can identify measures or indicators of |
| | system performance and the actions needed to improve or correct |
| | performance, relative to the goals of the system. |
| Monitoring | The degree to which someone can monitor/assess performance to |
| | make improvements or take corrective action. |
| Management of Personnel | The degree to which someone can motivate, develop, and direct people |
| Resources | as they work, and identify the best people for the job. |
| Instructing | The degree to which someone can teach others how to do something. |
| Monitoring | The degree to which someone can monitor/assess performance to |
| | make improvements or take corrective action. |
| Service Orientation | The degree to which someone actively looks for ways to help people. |

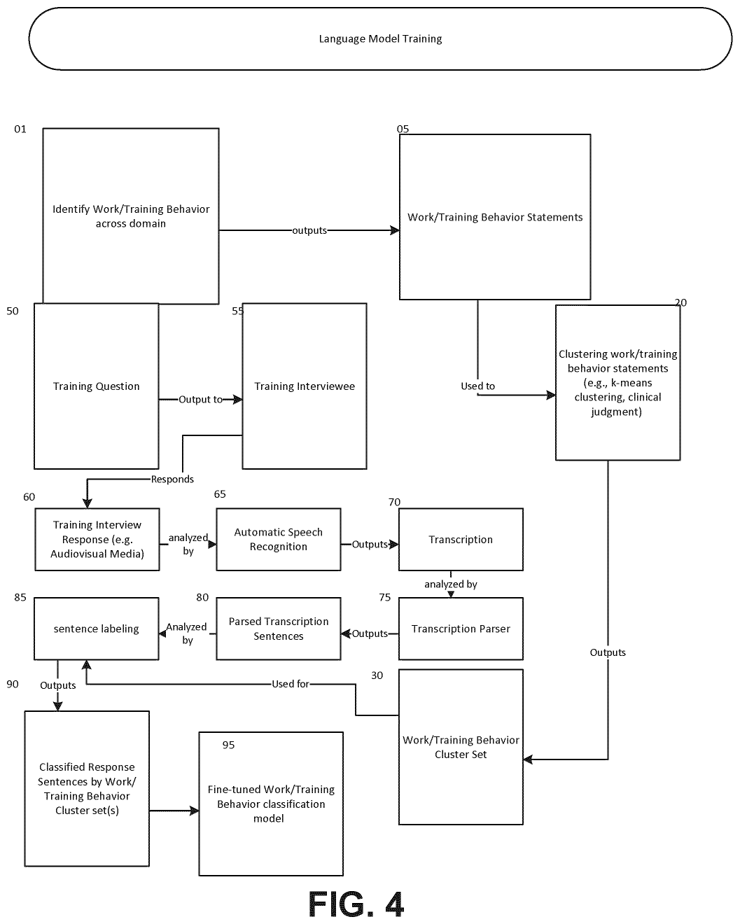

FIG. 4 depicts an example framework or process of training a natural language ML model to perform natural language processing. As depicted in FIG. 4, training a language model may include, for example, identifying work/training behaviors 01 to obtain work/training behavior statements 05.

In some embodiments, obtaining work/training behavior statements may require the use of existing labelled work/training behavior data (e.g. data with assigned labels which are known to be correct). Such data may include, for example, data sets from the O*NET which may be used to establish the universe of work/training behavior statements. In some embodiments, work/training behavior statements 05 may be used to develop clusters of work/training behavior statements 20 using mathematical clustering techniques. For example, k-means clustering can be used to identify an N-dimensional space. In other embodiments, work/training behavior statements 05 may be clustered using clinical judgement. In other embodiments, work/training behavior clusters can be derived using any process or procedure at that outputs clusters of similar work/training behavior. In some embodiments, behaviors may be considered on an individual basis without the use of clustering.

In some embodiments the output from clustering work/training behavior statements 20 may be a work/training behavior cluster set 30.

Some embodiments herein may make use of an interviewee's response 60 to a training question 50. To assess an interview response's content, it may be important to locate and classify work/training behavioral phrases outlined in a candidate's interview response. To do this, a corpus of manually annotated data may be required to train a ML model on recognizing what type of behavior is present within the interview response and between what time bounds. To build a dataset of manually annotated data, a team of human annotators may review sections of training interview responses 55 to identify what behaviors are present and where they are located in the transcript 85.

One way of creating a corpus of labeled behavioral data involves having humans annotate behavioral class and location. In some embodiments, a first, behavioral class ML model may rely on sentence-level annotation, which produces a corpus of labeled sentences. In some embodiments, a second, location-based ML model may rely on transcript-level behavior tagging and refinement, which produces a labeled corpus that has additional location information. In some embodiments, a first behavioral class and location information ML model may rely on word-level annotation, which may produce a labeled corpus that has behavioral class and location information. In some embodiments, a behavioral class ML model may rely on word-level annotation, which may produce a corpus of labeled transcripts.

The annotation process may begin by converting any audio or video recordings of a candidate's response 60 (or existing responses from a dataset) into a transcript 70 using one or both of automated speech recognition 65 and/or manual speech recognition. A goal may be to produce an accurate transcript 70 of the words spoken by a candidate. In practice, in some embodiments, transcription might only be necessary when a written answer to the interview question is not directly provided. In some embodiments, transcription may be performed manually, in whole or in part, to improve readability of transcripts when completing annotation. In some embodiments, errors in transcription may be re-introduced into the transcripts to build an ML model which is more robust to errors commonly present in automated transcriptions.

In some embodiments, the first phase of the annotation process is to analyze the behavioral content located within the transcript. This phase may be completed one sentence at a time, or at any other suitable increment (e.g. two sentences, three sentences, or any text passage of any length). One way to accomplish this is to split or parse the transcript into a series of semantically consistent passages with an open-source ML model. The annotation process may require a human annotator to analyze the content of a single sentence and determine from a pre-established list of behavioral clusters 30 which, if any, behaviors are present in at least some sub-sentence sequence of the sentence. The final output may be a corpus of labeled sentences used to train a standard multi-label classification model. In some embodiments, word level tags may be used which may be individual or multi-label tags.

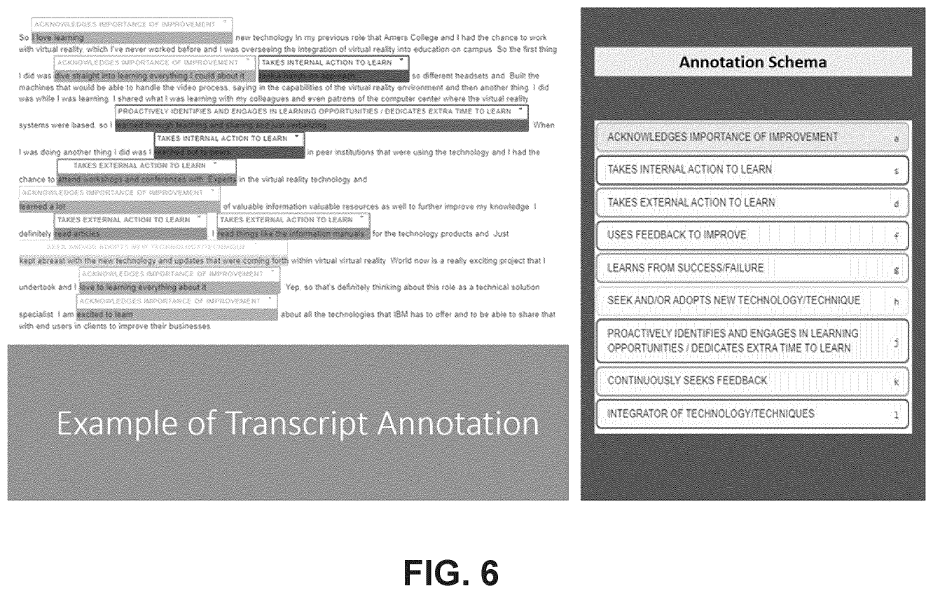

In some embodiments, a second phase of the annotation process may refine the location of the behaviors identified at the sentence level down to a more exact sub-sentence sequence of words that represent the behavior (as shown, for example, in FIG. 6). In one example embodiment, this may be accomplished by annotating sentences that were classified at the sentence level. This may also be accomplished by combining the pre-annotated sentences back into the original transcript with the boundaries of the sentence level annotations provided as highlighted sections of the transcript. The original annotations may then be refined so that words that convey the meaning of a classified behavior are included in the boundaries of the phrase. Additionally or alternatively, with the added context of the entire transcript, some behaviors may be added or removed from the original sentence to improve accuracy. In some embodiments, a two-step process may increase efficiency, accuracy, and objectivity, but might not be explicitly required to produce a transcript level annotation. An output may be a corpus of transcripts highlighted according to the locations and classifications of key behavioral phrases. This corpus may be used to train a custom multi-label segmentation model, such as fine-tuned behavior classification model 95.

In some embodiments, the content of key behavioral phrases manually identified may be correlated to the definitions of the work/training behavior clusters, and when a given sample is annotated independently by multiple annotators, there may be a high degree of agreement between annotators. In some embodiments, training material may be provided for annotators to increase a degree of agreement between annotators. In some embodiments, training and review sessions, as well as annotation discrepancy reduction exercises, may be included in the annotation process.

In some embodiments the work/training behavior cluster set 30 may be based on the O*NET. The O*NET provides a corpus of 2071 Detailed Work Activities (DWAs) categorized into 332 Intermediate Work Activities (IWAs) which are finally categorized under each of the 41 GWAs. The work/training behavior cluster set may be set at the GWA level, IWA level, or DWA level, or be another cluster set that is adapted from the O*NET work activity framework. To ensure adherence to the definitions outlined by the O*NET, a team of Subject Matter Experts (SMEs) may manually scrutinize the results of a subset of all samples. To ensure that each behavior is used correctly, the behaviors identified may be further categorized into the more specific IWA and DWA categories, or to alternative categories designed to reflect IWA or DWA categories, to increase the confidence of the GWA-based behavior cluster being present. When consensus is reached, the sample may be added to a corpus representing the ground-truth of the expected annotations to be applied.

In some embodiments, this corpus of ground-truth samples may be introduced into a list of new samples being annotated (e.g. at random, or at other intervals) to form a feedback loop within the annotation team. As deviations from the ground truth are identified, the annotators may be individually re-trained on common mistakes as a way to enhance adherence to the annotation guidelines. To further increase adherence, each sample may be independently annotated by at least two annotators and then compared. When disagreements arise, they may be reconciled by the team of SMEs.

To ensure high correlation amongst annotators, it may be necessary to be highly specific about the names and definitions of each of the behaviors being manually identified and categorized. To accomplish this, some of the GWA categories may be split into two or more individual behaviors, each representing the original GWA in the linkage. Therefore, each individual behavioral class may represent a subset of the IWAS underneath the GWA. This process may further narrow the definition of the behavior which increases the ability to be objective when annotating. The inter-annotator agreement amongst all annotators may be carefully tracked any time GWAs are split, and changes to the framework might only be maintained if an improvement in correlation is observed.

In some embodiments, using the sentence level corpus of labeled data, a sentence- or passage-level model(s) may be used to identify which behaviors are present within each sentence of a response to a question by an applicant. This may be modeled as a multi-label classification problem where the objective is to predict which classes a novel sentence belongs to. Using work/training behavior statements 05 and a language model 10, a language model of work/training behavior 15 may be generated.

In some embodiments, an open source language model (for example, BERT, WIKI, RoBERTa, or the like) may be used. As an example, BERT is a pre-trained language model trained on large corpuses of books and literature so that it has a base level of semantic understanding of what different words mean in context. The output embedding of each word as it outputs to a transformer may be connected through a fully connected layer to one output node per behavior being detected. In some embodiments, each of these outputs may represent a predicted probability of each behavior being present in the same sentence as that individual word and the weights of this fully connected layer may be shared amongst all words. In some embodiments, a label that was given for an entire sentence may be replicated across each of the words and binary cross entropy with logits loss may be used to fine tune the model to replicate the training set.

Alternatively, in some embodiments, another possible architecture is to take a mean pooling (average) of the token output of each word from the output of the transformer and pass it through a single instance of the classification head for the entire sentence rather than replicating the label and individually classifying each word. In this case, a word level prediction may still be obtained by analysing the output of each token individually with the single classification head despite it being trained with the averaging layer.

Also depicted in FIG. 4, training questions 50 may be presented to a training interviewee 55. The training interviewee(s) may provide responses 60 to the questions 50. The response (which may be textual, audio, and/or audiovisual) may then be analyzed by automatic speech recognition 65 to obtain transcript 70. Transcript 70 may then be parsed by transcription parser 75 obtain parsed transcript sentences, which are then analyzed by sentence labelling analysis 85 in accordance with work/training cluster set 30 to obtain classified response sentences 90 which may also be used as training data. Classified response sentences 90 are used as training data to train fine-tuned work/training behavior classification model 95.

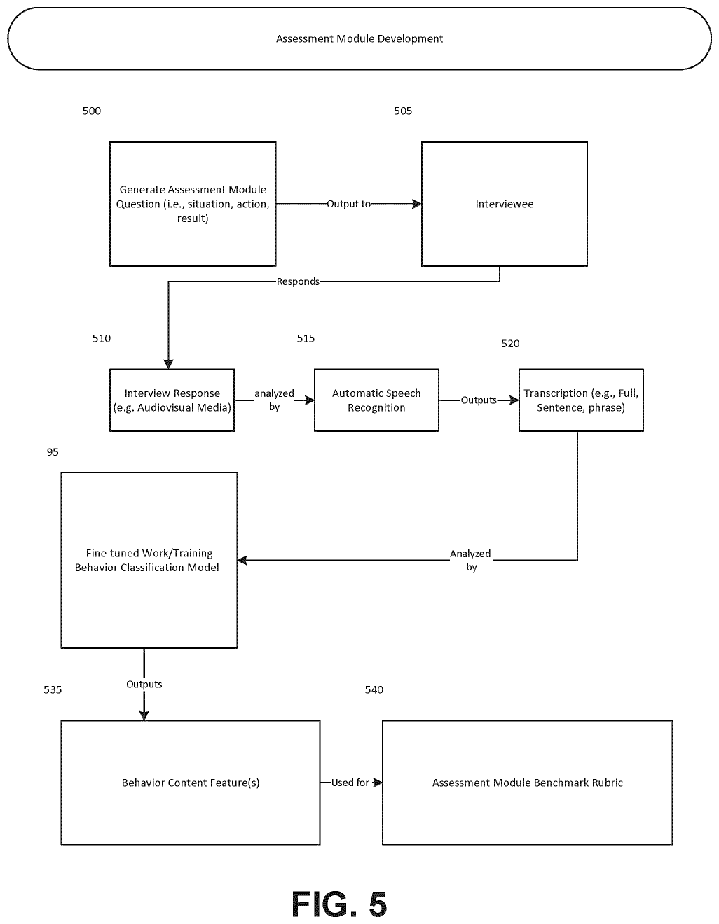

FIG. 5 is a simplified diagram of a process for building an assessment module. In some embodiments, an assessment module may be configured to evaluate a transcript for one particular skill deemed necessary or particularly relevant. As depicted, the process begins with generating one or more assessment module questions at block 500.

It will be appreciated that questions presented to interviewees will preferably be developed to facilitate automated scoring. Therefore, questions may follow a format expected to elicit useful behavioral data from interviewees. The most useful results may come from questions that ask an applicant/interviewee to describe a situation, explain how they responded to that situation, and the outcome.

In addition, questions may be developed to have content validity. That is, a question used to measure a skill should aim to elicit behavior that is related to the skill. For example, when measuring growth mindset, questions should focus on work experience that involved learning, growth, or development. Through the PI to GWA linkage already established, this process can be facilitated by identifying the most relevant behaviours that correlate with the given organizational skill.

At block 505, questions are presented to an interviewee, who will then respond to the question at block 510. In some embodiments, responses may be audiovisual in nature. In other embodiments, responses may be text or audio formats. At block 515, the response may be processed through automated speech recognition and converted to a text transcript 520. Transcript 520 may then be analyzed by fine-tuned work/training behavior classification model 95.

In practice, when evaluating a candidate, the candidate's response may be processed into a transcript which is parsed into sentences in a same or similar way as data is prepared for annotation. The fine-tuned ML model 95 may analyze one sentence (or other text passage or increment) at a time, to produce behavior content features 535. In some embodiments, behavior content features include the probability of each word belonging to a given behavioral class. In some embodiments, the sum of behavior probabilities across all words in the sentence may be taken to represent a “quantity” of each behavior existing in the sentence. The sum of all sentence level quantities may be taken across the transcript to obtain a quantity score of each behavior across the entire transcript. In some embodiments, a checklist is used to obtain a quantity score of each behavior.

In addition to sentence- or passage-level analysis, some embodiments may use a transcript level corpus of labeled data, and the resulting ML model may produce a segmentation heatmap. The heatmap represents the probability that each word is part of a phrase with arbitrary start and end positions and representative of a particular set of behaviors. This may be analogized to pixelwise multi-label segmentation commonly seen in computer vision, instead with words/tokens instead of pixels.

In some embodiments, the transcript-level ML model may be based on the open-source language model BERT. The output embedding of each word as it outputs from a transformer may be connected through a fully connected layer to one output node per behavior being detected. Each of these outputs may represent a predicted probability of each behavior being present by that word. The weights of this fully connected layer may be shared amongst all words. Unlike with sentence- or passage-level analysis, transcript-level modelling may analyze the whole transcript in the aggregate with the label of each word representing all the behavioral classes that the given word has been highlighted by in the annotation process. A multi-label version of focal loss may be used to account for the inability to up-sample underrepresented behaviours because behaviours are bound to common transcripts.

With a heatmap representing the probability of words belonging to any number of behaviors, the same process of aggregating the sum of behavioral content in the transcript may be used. The sum of the probabilities of each behavior across all words in the transcript forms a quantity score of each behavior across the entire transcript.

After transcript 520 is analyzed by fine-tuned work/training behavior classification model 95, behavior content features 535 are output, which are in turn used to calculate one or more skill scores and rankings.

Behavior content features 535 (e.g. behavior scores or probabilities) may be converted into non-technical skill scores by weighting each behavior by a linear relationship between behavior and skills (determined from, for example, data from O*NET). In the case of multiple non-technical skills being included in a more holistic skill (e.g. Growth Mindset), an equal weighting across non-technical skills may be used (however, non-equal weightings are contemplated) unless otherwise specified by the user.

In some embodiments, a threshold number of candidate responses is used to measure a skill. For example, after 30 candidates have responded to a new question that has been developed to measure skill, it can be validated. Raw skill scores may be standardized at the question level. Validated assessment modules may have a mean and standard deviation. Therefore, candidates may receive a standardized skill score based on the magnitude of the behavior contained within their transcript against the average magnitude of behavior for responses to a specific question. The standardized scores may be converted into percentiles, which may then be used to rank-order applicants for the skill being measured. If multiple skills are measured as part of an assessment, an equally-weighted average percentile may be generated (although other weightings are contemplated) unless otherwise specified by the user.

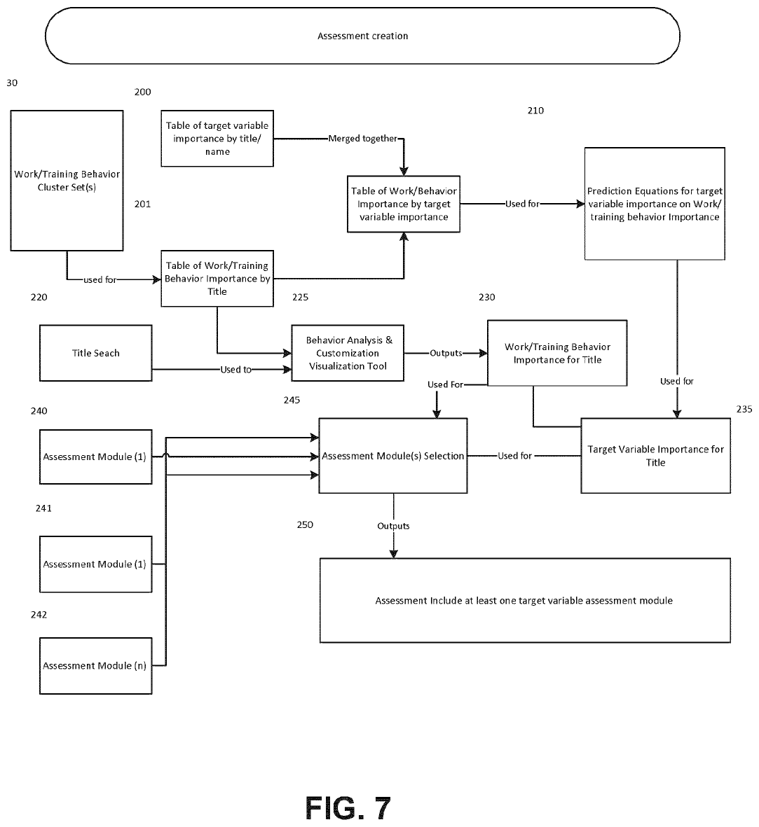

FIG. 7 is a simplified diagram for a process of creating assessments for candidates. For example, for a given job posting, questions may be formulated which target specific skills identified as being required or most relevant for the job. A database such as the O*NET may be used for a lay title data set to identify links between work roles and occupational titles, and aid in determining the appropriate job title to be listed in a posting. Tables of target variable importance by title/name 200 and work/training behavior importance by title 201 may be combined into a table of work/behavior importance by target variable importance 205, which can be used for prediction equations for target variable importance on work/training behavior importance 210, which can be in turn be used to determine target variable importance for a job title, together with work/training behavior importance for a job title. The appropriate selection modules 240, 241, 242 for the role may then be selected and included for evaluating at least one target variable 250.

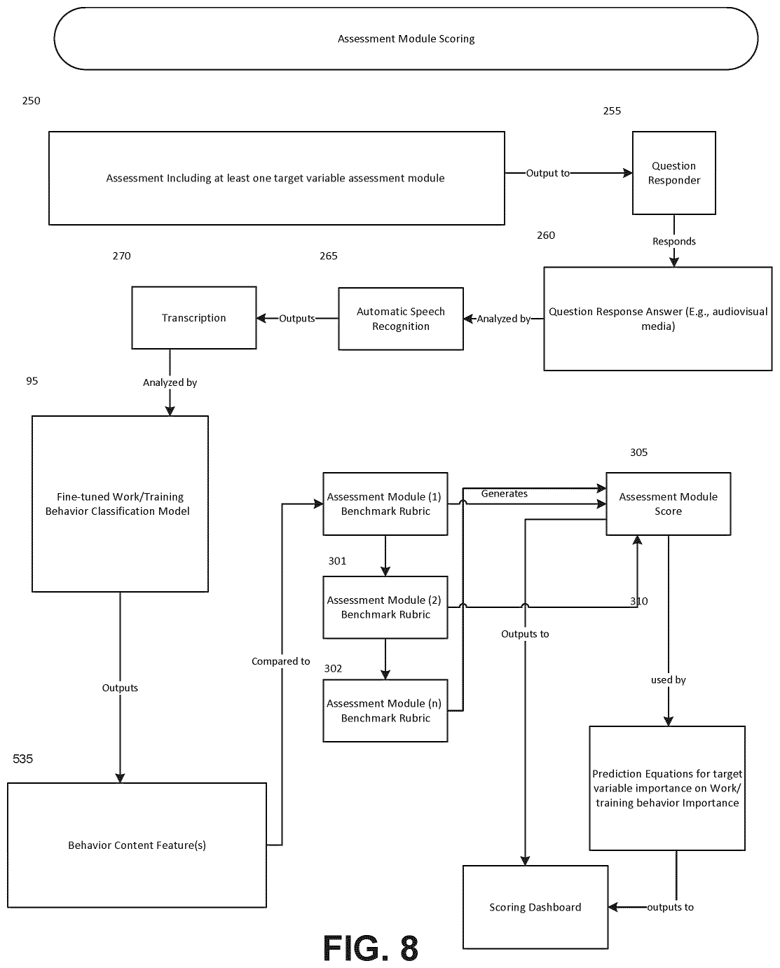

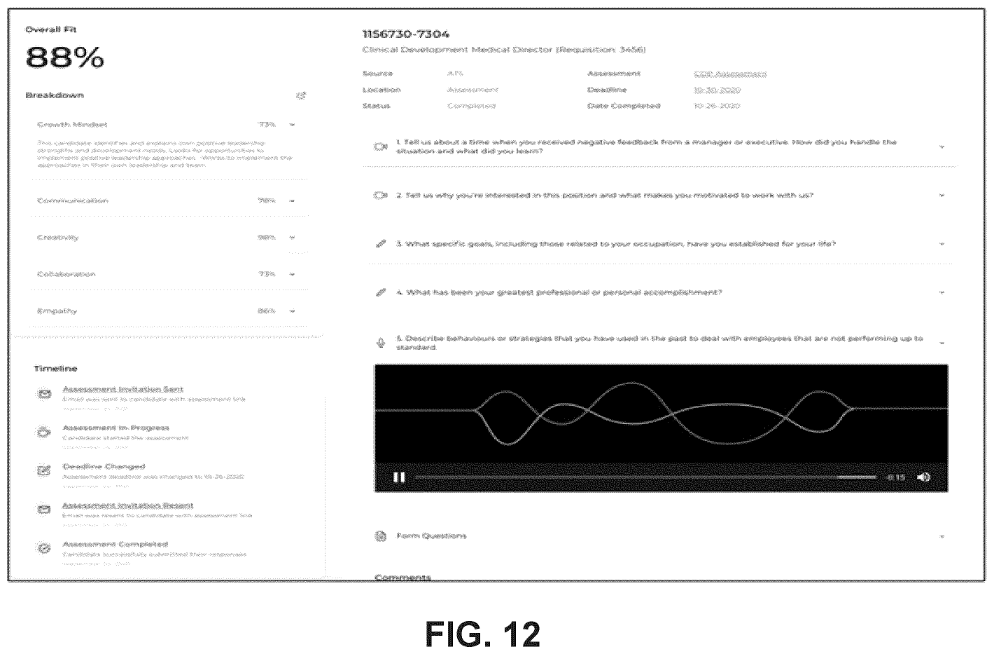

FIG. 8 is a simplified diagram of a process for assessment module scoring. At 250, an assessment is provided to a candidate 255, who will then provide a response at 260. The response may be converted from video to a transcript 270 via automatic speech recognition 265, and then the transcript will be analyzed by fine-tuned behavior classification model 95. The classification model 95 outputs behavior content features 535 in accordance with the systems and methods described herein, which are then compared to its corresponding assessment module benchmark rubric 300, 301, 302, which then provide an assessment module score 305. The assessment module score 305 may be output to a scoring dashboard (e.g. a graphical user interface indicating the candidate's score and optionally a breakdown of the basis for the score), and the score 305 may also be used by prediction equations for target variable importance on work/training behavior importance, which may also be output to the scoring dashboard (an example scoring dashboard is depicted in FIG. 12).

Broadly speaking, in some embodiments, assessments may follow the path of identifying the skills required or most relevant for assessing candidates, and then including skill assessment modules (e.g. including ML models at the sentence-level and transcript-level) for each of said skills. The responses from a candidate may then be transcribed into text, and then analyzed using natural language processing using the assessment modules for each skill, resulting in “behavior content” scores for each skill. In some embodiments, standardized behavior content scores may be mapped to performance indicators (PIs) using regression analysis, which may in turn be used to generate skill scores using a weighted sum of PI scores (e.g. with weighting based on the importance of each PI).

In some embodiments, behaviour content scores can be used as features in another ML classification or regression model to predict other targets. Behavior content features can be trained to predict job performance and/or employee turnover.

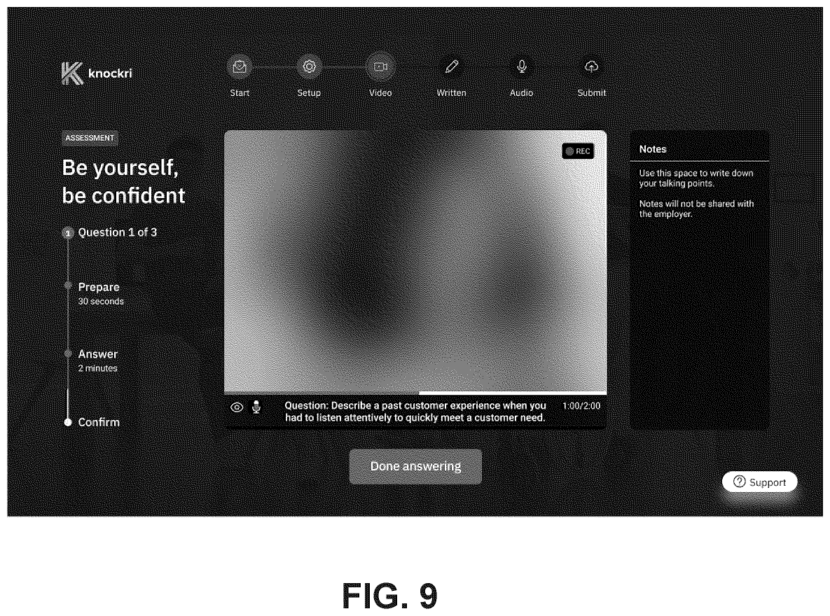

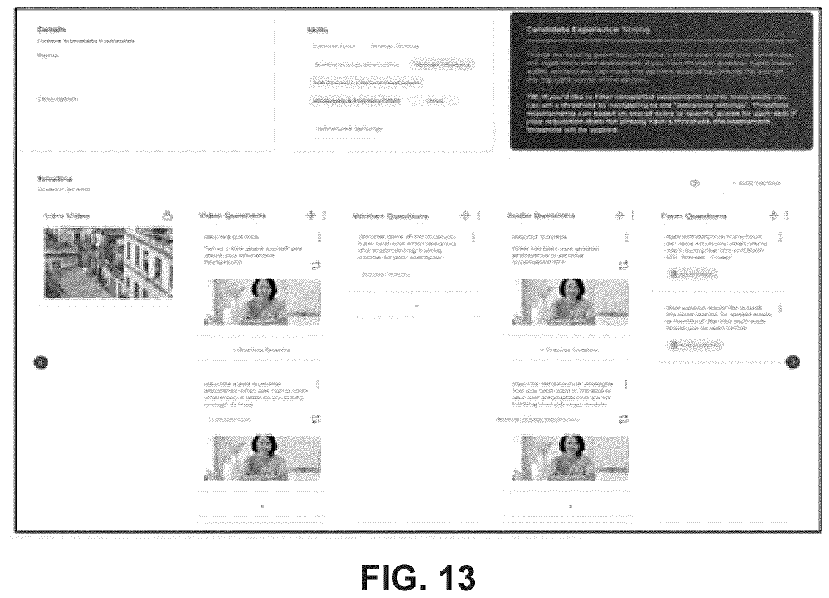

In some embodiments, an assessment may be presented to a candidate for a job via a graphical user interface. FIG. 9 is an example of a graphical user interface which may be presented to a candidate. As depicted, the example interface (or dashboard) contains a question, a video or audio interface for recording an answer to the question, and an area for writing down talking points. Although FIG. 9 depicts a video interface, some embodiments may include an audio interface without a video interface. In some embodiments, a recruiter may customize which of the depicted elements are included in an assessment prior to the assessment being made available to a candidate (e.g. via a recruiter dashboard, as illustrated, for example, in FIG. 13).

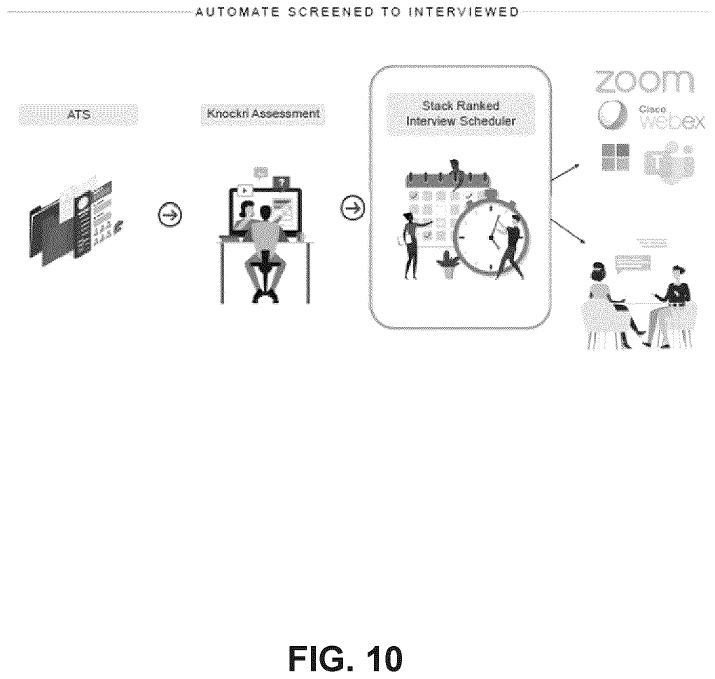

In some embodiments, the answers provided to an assessment by a candidate may provide a more objective and accurate basis for evaluating and comparing candidates, and may also reduce the time spent evaluating candidates. For example, rather than an employer or recruiter engaging in numerous rounds of resume assessment, phone interviews, and other evaluations with prospective candidates prior to a full interview, the systems and methods described herein may effectively reduce the process to the posting of a job role, evaluation using the automated systems described herein (after the candidate has completed the various assessments presented to them), and then selecting a final number of candidates for a full interview based on the scores obtained from the automated evaluations (as shown in FIG. 10).

In some embodiments, the systems and methods described herein may result in an increase in racial and gender diversity of candidates shortlisted for a given position relative to subjective human-made evaluations of candidates. Moreover, systems and methods described herein offer increased transparency, as the models used to generate scores are explainable, which may be beneficial in complying with regulatory requirements in various jurisdictions.

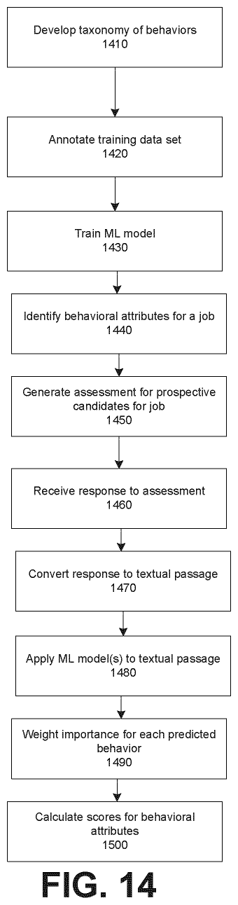

FIG. 14 is a flow chart depicting an example process 1400. As depicted, process 1400 includes developing a taxonomy of behaviors 1410, annotating a training data set 1420, training an ML model 1430, identifying behavioral attributes for a job 1440, generating an assessment for prospective candidates 1450, receiving a response to said assessment from one or more candidates 1460, converting response to a textual passage 1470, applying ML models to said textual passage 1480, weighting the importance for each predicted behavior 1490, and calculating scores for the behavioral attributes 1500.

At 1410, a taxonomy of behaviors that can be described and identified in a textual passage may be developed. This taxonomy may be used for one or more of training and/or prediction. In some embodiments, classification may of behavior may be binary (i.e. a particular behavior may be classified as being present or not present). A pre-existing list of behaviors may be used, such as, for example, the O*NET content model described above. In some embodiments, a pre-existing list of behaviors can be adapted by one or more of changing the names of different behaviors, including additional behaviors, and/or adding a permutation of a list of behaviors contained within a pre-existing list of behaviors.

In some embodiments, annotators may review input textual passages and discover examples of behavior not included in the current taxonomy of behaviors used for annotation and/or prediction. Additional behaviors may be added to the taxonomy of behaviors based on patterns in the dataset where existing behaviors do not capture a work/training behavior included in a textual passage.

In some embodiments, the taxonomy of behavior may be hierarchical. For example, when a more specific behavior is present, it may be implied that a more general “parent” behavior is also present. For example, the specific behavior “assigning work for others” may have a more general behavior (e.g. “managing personnel”) associated therewith in the taxonomy. In some embodiments, the more general behavior may be associated with a further general behavior (e.g. “managing personnel” may be associated with “managing”).

In some embodiments, classification may be with reference to a subject who is exhibiting the described behaviors in the taxonomy. In some embodiments, classification may be with reference to the tense of the described behaviors. In some embodiments, classification may be with reference to the context of the described behaviors.

At 1420, textual passages in a training data set may be annotated to identify the classification and/or location of behaviors associated with the textual passages. A number of different strategies may be implemented to break a larger input text passage into multiple smaller subsets. In some embodiments, smaller subsets may be easier to process from a computational standpoint. In some embodiments, the entire input text passage may be annotated without any cropping, windowing, or subdivision into subsections. In some embodiments, the input text passage may be split into sentences wherein each sentence is treated as an independent sample for annotation. In some embodiments, some or all of these sentences may be annotated as a group to maintain context across the entire textual passage.

In some embodiments, the text input may be split into an arbitrary number of arbitrarily long subsections of the input text passage at arbitrary locations within the passage. Each subsection may be treated as an independent sample for annotation. In some embodiments, these subsections may be annotated as a group to maintain context across the entire text passage.

In some embodiments, the input text passage may be split into fixed size windows with a fixed stride to break the input textual passage into multiple smaller overlapping subsections. In some embodiments, this may allow for consistent processing of arbitrarily long input textual passages.

Various strategies may be used to identify the location of behavior associated with the text passage. In some embodiments, existence of a behavior may be annotated by tagging an entire input passage, which may represent either the entire input text passage or a subsection of the input text passage. In some embodiments, existence of a behavior may be annotated by tagging one or more subsections of the input passage (e.g. by highlighting). A subsection may range in size from a character/token/word and as large as the entire text passage (whether the full passage or a subsection of the full text passage). In some embodiments, existence of a behavior may be annotated by tagging one or more verbs that are used to describe the behavior.

Various strategies may be used to identify a classification of behavior based on one or more behavioral taxonomies. In some embodiments, a binary approach may be used wherein for a single behavior in the taxonomy, a binary value (e.g. true or false) is selected to represent the classification of the behavior at the identified location(s). In some embodiments, a multi-class/one-label approach may be used wherein a single behavior in the taxonomy is selected to represent the classification of the identified behavior at the identified location(s). In some embodiments, behaviors in the taxonomy may be selected from a single hierarchical level of behavior to represent the classification of the identified behavior at the identified location(s). In some embodiments, behaviors in the taxonomy may be selected from multiple hierarchical levels of behavior at the same time to represent the classification of the identified behavior at the identified location(s). The behaviors in different hierarchical levels may be linked, which may indicate that the behaviors in different hierarchical levels represent the same or similar behaviors. In still other embodiments, one or more behaviors from one or more independent or linked taxonomies may be selected to represent classification of the identified behavior at the identified location(s). Such behaviors may be linked together to create clusters of behaviors.

In some embodiments, labeling strategies may be implemented to increase enhance the accuracy of annotations. In some embodiments, multiple team members may analyze a same dataset and have results compared and reviewed by another individual or group of team members. During such a review, different options may assessed, with some being accepted while others may be rejected.

At 1430, a machine learning (ML) model is trained to predict one or more behaviors based on an input text passage (which may be a sentence, a subsection of a larger text passage, a paragraph, the full text passage, or the like). In some embodiments, a deep learning model (e.g. a Sentence BERT transformer model) may be trained to semantically differentiate language from each class of behavior. The ML model may, for example, be provided with annotated text passages as triplets in which two out of three text passages shares a behavior classification and the third does not. This may allow the ML model to be trained with triplet loss to gain a more refined understanding that similar inputs may represent similar semantic concepts. In some embodiments, a deep learning model may produce a latent embedding vector which represents the semantic content of the input text passage, which may then be used to determine behavior.

In some embodiments, a deep learning model (e.g. a BERT transformer model) may be trained to perform one-label or multi-label classification based on the input text passage (which may be a full text passage, a paragraph, a sentence, a subsection or a larger text passage, or the like). The model may be provided with some or all of the text passages along with the annotations and be trained to predict the classification of novel input text passages.

In some embodiments, a deep learning model (e.g. a BERT transformer model) may be trained to perform question answering. The model may be provided a question to identify one or more instances of one or more behaviors in a provided context (e.g. an input text passage, such as a full text passage, a paragraph, a sentence, or a subsection of a larger text passage) at once. In some embodiments, the output may be a representation what span(s) of text from the input context pertain to a desired behavior. For example, if given the question “Find where they are selling or advertising” and the context of “In my last job I sold products to customers”, an example output from the ML model could be the single span “sold” indicating that the behavior asked in the question is present at that location in the context.

In some embodiments, the output of the transformer at each token may be a classification of true or false, which represents if that token pertains to a behavior of interest. In some embodiments, the output of the transformer at each token may be split into two outputs (e.g. one output representing whether that token is the start position of a span of tokens, and the other representing if that token is the end of a span). These two outputs across all tokens may be compared and grouped into one or more spans of any length within the context.

In some embodiments, the same context may be used to ask the model a plurality of questions. In some embodiments, there may be one question for each behavior of interest in one or more taxonomies. The resulting output of some or all questions may be pooled together such that the single textual input has a multi-class output.

In some embodiments, spans of text in the output from the transformer might represent only the verbs which pertain to the behavior. In some embodiments, spans of text in the output from the transformer might represent a self-consistent multi-word subsection of text which describes the classified behavior without any additional context outside that span required. In some embodiments, the spans of text in the output from the transformer might not represent a self-consistent multi-word subsection of text that describes the classified behavior on its own, and instead may require other subsections of text from the same input text passage to provide context. In these instances, links may be made between spans to signify the necessary context for each identified behavior.

At 1440, one or more behavioral attributes required for a job may be identified. In some embodiments, attributes for the job may be determined through job analysis conducted using a method involving subject matter experts (i.e. those with a good understanding of the job and/or individual attributes required for performance in a job). In some embodiments, attributes required for the job may be determined through an application of a pre-established understanding of the importance of different behavioral attributes for the job. In one example, the O*NET described above may provide an indicator of the importance of attributes such as Skills, Work Styles, and Work Activities across a range of occupational personas or job titles. In some embodiments, the most important attributes by rank order, or most predictive combination may be selected. In some embodiments, O*NET-provided attributes may be linked through a content linkage and clinical judgment to other attributes (such as skills specific to an organization's core culture) such that the most important client-specific skills may be selected based on O*NET importance data. In some embodiments, linking the requirements of a job to attributes to be assessed may be performed using any method, including random sampling of attributes. In some embodiments, a user may define the set of attributes required for the job. In some embodiments, expert judgment may be used to identify important attributes for a job by examining prior art, or by examining job content information (e.g. a job description). In some embodiments, a behavioral attribute may reflect the requirements of a job and reflect critical work behaviors which are required to perform on the job, wherein the behavioral attribute is a person-job fit.

At 1450, an assessment is generated for prospective candidates for a job. In some embodiments, the assessment may include one or more questions targeting evaluation of said one or more behavioral attributes. In some embodiments, the assessment may include one or more interview questions targeting evaluation of said behavioral attributes. In some embodiments, an assessment may include one or more interview questions selected based on the attributes each interview question is known or expected to measure in response. In some embodiments, the assessment may be a set of interview questions selected because of the behaviors interview questions are known or expected to elicit, which may be indicative of behavioral attributes. In some embodiments, the assessment may be a filtered set of interview questions known or expected to elicit specific or general behaviors for the purpose of optimizing coverage over a pre-established set or list of behaviors. In some embodiments, the assessment may include one or more interview questions selected based on the results of statistical models that indicate the best one or more interview questions for a given a context.

At 1460, a response to the assessment is received from one or more prospective candidates. In some embodiments, the response includes audio and/or written data. In some embodiments, responses may be recorded in a live setting (e.g. synchronously), whether in-person, over the phone, in a virtual meeting room, via video-conference, or any other suitable way of having a live conversation. In some embodiments, interview questions may be pre-recorded, and prospective candidates may be required to watch a pre-recorded interview question and then record a response using a voice recording device. In some embodiments, responses to live or recorded interview questions may be given in writing by the prospective candidate.

At 1470, if the response includes audio data, the audio response is converted to a text passage. Conversion to a text transcript may be performed, for example, by automated speech recognition services. In some embodiments, the automated speech recognition service may employ machine learning models. In some embodiments, conversion to a transcript may be performed by having humans listen to and transcribe the audio into a manually generated transcript of the response. In some embodiments, a combination of automated speech recognition and manual human speech recognition may be employed (e.g. to increase accuracy of automated transcripts).

At 1480, machine learning models are applied to the text passage to identify predicted behaviors. In some embodiments, the set of behavior classes to identify is pre-selected. These selected behavior classes may form the list of predicted behaviors that the ML model is seeking to identify in the input text passage. In some embodiments, the input text passage may be pre-processed by, for example, processing one or more punctuation, capitalization, windowing/cropping, padding, or the like. In some embodiments, the output predictions of the ML model may be formatted in a manner consistent with the annotations in the training data sets. In some embodiments, the ML model may output a probability or confidence level for each identified behavior, which may be used to weight the prediction by said probability and/or confidence level. In some embodiments, the ML model may output a probability or confidence level for each identified behavior, which may be used to convert the behavioral prediction into a binary class depending on a predetermined threshold level for each probability. In some embodiments, the ML model may output tags at the token, word, phrase, or overall text passage level, or any combination thereof. In some embodiments, the ML may have a natural language understanding of the behavior classes in the behavioral taxonomy, and any behaviors and/or classes including those outside of the taxonomy used in training may be predicted by the ML model.

At 1490, the importance of each predicted behavior related to the behavioral attributes may be weighted. In some embodiments, the importance of the one or more predicted behaviors related to the behavioral attributes may be determined by considered the importance of a behavior to a behavioral attribute and the relationship of a behavioral attribute to a client skill. For example, importance of a behavior to an attribute may be determined through a correlation between the importance of a behavior rated between 0 and 1 and the importance of a skill rated between 0 and 1 across a set of job examples. The correlation may provide an indication of the importance of a behavior based on the importance of a skill for a given job role.

In some embodiments, importance of one or more predicted behaviors to behavioral attributes may be determined by one or more of expert judgment, theoretical derivation, or derived from prior research. For example, the importance of a behavior may be determined by drawing in behavior importance of a pre-established behaviorally anchored rating scale. In a behaviorally anchored rating scale, importance can reflect the position of behavior along a continuum that may range from, for example, 1 to 5, with different behaviors considered at each independent level.

In some embodiments, the importance of predicted behaviors related to behavioral attributes may be determined using the importance of predicted behavior to a job. For example, the O*NET may be used to identify the importance of each behavior in a behavior taxonomy. The importance value for each behavior may then be used to weigh the importance of each behavior identified in the text passage. In some embodiments, the importance of predicted behaviors to behavioral attributes may be determined using any of research, methods, procedures (e.g. statistical analysis) that provide an indication of the importance of a behavior to a behavioral attribute.

At 1500, scores may be calculated for behavioral attributes. In some embodiments, scores may be calculated using a combination of importance and identification of predicted behaviors. In some embodiments, scores may be calculated through use of a rubric. A rubric may be a scoring tool or checklist which explicitly identifies the behaviors and/or combinations of behaviors considered relevant for measuring a behavioral attribute and may further include information regarding the importance or the weight or amount of credit received for each behavior and/or combination of behaviors considered relevant for measuring behavioral attributes. A rubric may further still contain information about the criteria required to receive credit for each predicted behavior.

In some embodiments, a rubric may be configured in a manner which allows for credit to be given for predicted behaviors if a precondition is met. For example, to receive credit for one or more predicted behaviors, one or more other predicted behaviors may be required to be present within the text passage.

Some embodiments may use benchmarks during scoring. In some embodiments, a benchmark may be an absolute or standardized indicator of performance. A benchmark may be used to determine the quality of a text passage against an ideal standard for a text passage. Thus, a benchmark may reflect a standardized estimate of the behavior contained within an average text passage. The standardized elements may be developed based on a minimum number of samples (e.g. 30) of text passages, and text passages may come from any reference group considered to be relevant for the purpose of developing a benchmark. In some embodiments, the standardized estimate may be projected as a mean and standard deviation of said predicted behaviors. In some embodiments, benchmarks may be set as an absolute number of behaviors that are contained within a text passage.

In some embodiments, scoring 1500 may include using rubrics and/or benchmarks. Scores of a behavioral attribute may be calculated to reflect a quantity of weighted behavior, or another quantitative metric including but not limited to text passage length, word count (i.e. behavior credit). A score may be calculated as an absolute quantity or a relative quantity (of behavior). In some embodiments, the available credit for each predicted behavior may be capped by a predetermined saturation value such that no additional credit is given after a maximum credit quantum has been reached.

In some embodiments, calculating scores for a behavioral attribute may be a simple checklist, or a weighted checklist, and may reflect one or more counts of behavior. In some embodiments, calculating scores of a behavioral attribute may be determined by using the behavior quantity or checklist metrics as features in a supervised or unsupervised deep learning machine model, targeting any meaningful work-related outcome (for example, job performance, turnover, and/or employee attitudes). In some embodiments, feature weights produced from a supervised or unsupervised deep learning machine model targeting a work-related outcome may be used to generate a predicted score for the work-related target using input behavior predictions. The predicted score may then be used as a proxy to infer the behavioral attribute.

In some embodiments, the machine learning model may be a linear machine learning model, targeting any meaningful work-related outcome. Using feature weights produced from the linear machine learning model, input behavior predictions can be used to generate a predicted score for the work-related outcome target, with the predicted score being used as a proxy for inferring the behavioral attribute.

In some embodiments, scores for a behavioral attribute may be determined using the behavior quantity or checklist metrics as features in a linear or non-linear statistical model, targeting any meaningful work-related outcome. Using feature weights produced from said linear or non-linear statistical model, input behavior predictions can be used to generate a predicted score for a work-related outcome target, wherein the predict score can be used as a proxy for inferring the behavioral attribute.

In some embodiments, scores for a behavioral attribute may be calculated using behavior quantity or checklist metrics as features in a shallow machine learning model, targeting any meaningful work-related outcome. Using feature weights produced from the shallow machine learning model, input behavior predictions can be used to generate a predicted score for a work-related outcome target, wherein the predicted score can be used as a proxy to infer the behavioral attribute.

In some embodiments, scores for a behavioral attribute may be calculated using the behavior quantity or checklist metrics to provide an inference of the behavioral attribute.

Sentence-level prediction has limitations, since behaviors may span across the boundaries of multiple sentences. Without the additional context of sentences before or after, it is difficult or possibly impossible to accurately identify the presence of a particular behavior. Moreover, behavior might not exist across the entirety of a sentence, despite the fact that some behaviors may only be represented by a portion of a sentence. This can result in over-representation of behaviors that are only represented by a few words of an entire sentence.

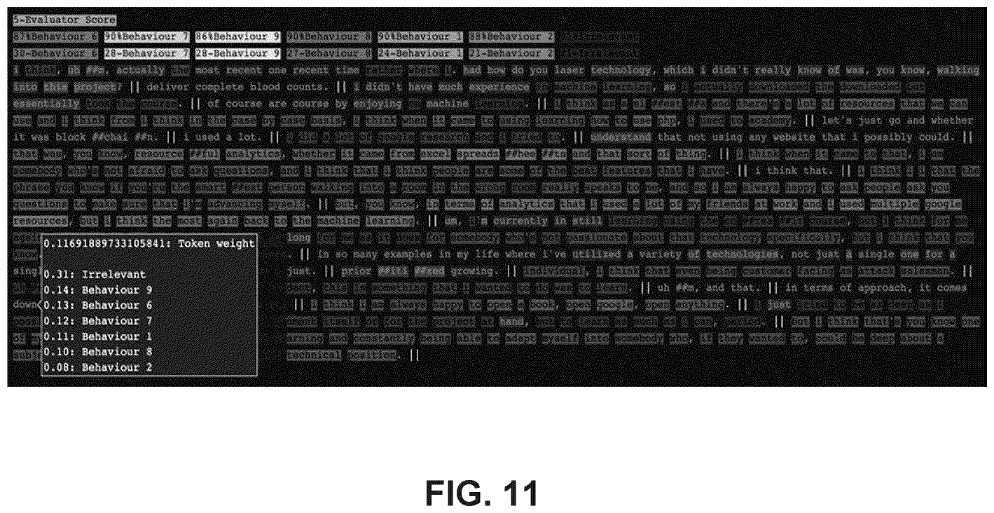

In some embodiments, the transcript-level analysis approach combined with the sentence- or passage-level approach may provide an unparalleled level of explainability and understanding as to exactly where credit is being given in the transcript for a given behavior. The exact boundaries of key behavioral phrases allow for the key phrases to be automatically parsed out and displayed to the user (see, e.g. FIG. 11). This offers a clear explanation of what content is being considered in scoring, and the skill to behavior mapping offers a clear understanding as to how each behavior is weighted in the scoring process. This approach may solve a fundamental problem associated with using AI processes in hiring selection by offering clear transparency and objectivity, which supports content validity and job relevance.

In some embodiments, candidate performance may be monitored after hiring a candidate, and subsequently fed back into the system. Thus, post-hire performance can be used to refine models to target skills and behaviors with increasing accuracy over time, which may yield better retention of candidates long term.

Unlike known methods for evaluating and classifying applications and their behavior, systems and methods described herein may provide an AI breakdown of each attribute upon which a candidate was evaluated. Thus, greater transparency may be achieved.

Of course, the above described embodiments are intended to be illustrative only and in no way limiting. The described embodiments are susceptible to many modifications of form, arrangement of parts, details, and order of operation. The invention is intended to encompass all such modification within its scope, as defined by the claims.

What is claimed is:

1. A method of automating a behavioral interview to identify behavioral attributes in a text passage, the method comprising:
developing a taxonomy of behaviors;
annotating a training data set of text passages to identify a classification and/or location of behaviors associated with the text passages;
training a machine learning model to predict one or more behaviors based on an input text passage;
identifying one or more behavioral attributes required for a job;
generating an assessment for prospective candidates, said assessment including one or more questions targeting evaluation of said one or more behavioral attributes;
receiving a response to said assessment from one or more prospective candidates, wherein said response includes at least one of audio and text data;
converting said response to a text passage;
applying said machine learning model to said text passage to identify one or more predicted behaviors;
weighting an importance for each of said one or more predicted behaviors;
calculating scores for the behavioral attributes using at least one of said importance and said identified predicted behaviors.

2. The method of claim 1, wherein converting said response to a text passage comprises using automated speech recognition service on said audio data.

3. The method of claim 1, wherein said calculating scores comprises applying at least one of a rubric and a benchmark.

4. The method of claim 1, wherein said taxonomy of behaviors includes a binary classification of behaviors.

5. The method of claim 1, wherein applying said machine learning model comprises applying said machine learning model to a subsection of said text passage.

6. The method of claim 1, wherein said text passage is at least one of an entire input text passage, a paragraph, a sentence, or a subsection of said input text passage.
